(19) United States
(12) Patent Application Publication
(10) Pub. No.: US 2020/0204212 A1
(43) Pub. Date: Jun. 25, 2020

(54) LAST METER WIRELESS BROADBAND

(71) Applicant: ARRIS Enterprises LLC, Suwanee, GA (US)

(72) Inventors: Darren Fawcett, Leeds (GB); Ian Anthony Clarke, West Yorkshire (GB)

(21) Appl. No.: 16/227,539

(22) Filed: Dec. 20, 2018

(51) Int. Cl. H04B 5/00; H04B 10/112; H04B 10/116

(52) U.S. Cl. CPC H04B 5/0037; H04B 10/116; H04B 10/1129

(57) ABSTRACT

Customer premises equipment (CPE) includes separate outdoor and indoor data communication units between which wireless optical data communications are transferable through a window of a building. The outdoor data communication unit has an optical transceiver for transmitting and receiving the wireless optical data communications and a wireless power transfer unit for powering the optical transceiver. The indoor data communication unit has a corresponding optical transceiver for transmitting and receiving the wireless optical data communications and a wireless power transfer unit for powering or charging the wireless power transfer unit of the outdoor data communication unit by wireless power transfer.

### BACKGROUND

In telecommunications, the term broadband refers to a wide bandwidth data transmission which is able to transport multiple signals and traffic types. This type of data transmission of a relatively large amount of data can be provided over a single medium such as a cable or the like and permits multiple users to simultaneously access the Internet and like networks and related services provided thereby at high speeds.

By way of example, broadband access may be provided to a local area network (LAN), wireless area local network (WLAN), or the like to consumers at a customer premises, building, home, facility, apartment building, business, residence, or the like by connecting Customer-Premises Equipment (CPE) (i.e., communications equipment that resides on the customer's premises) to an access network, wide area network, the Internet. or like external network. For instance, a cable modem may be used to connect the local area network to a cable access network; an optical network termination (ONT) modem or like device may be used to connect the local area network to a Fiber to the Home (FTTH) network (i.e., optical fiber network); a Satellite (SAT) to Internet Protocol (IP) modem or like device may be used to connect the local area network to a Direct-To-Home (DTH) television network (i.e., reception of satellite signals with a personal dish installed at the customer's premises); or a cellular mobile communication modem or the like may be used to connect the local area network to a cellular mobile communication network (i.e., 5G network or the like).

The so-called “last meter” of access to broadband provided to a consumer is the part of the network that delivers broadband access from an electrical component adjacent and exterior a home or like building at a customer premises to the local area network provided within the home or customer premises (i.e., from the “edge of the curb” into the home). A typical installation requires an installer to drill a channel through a wall or roof of the building and to extend data and/or power cables through the wall or roof needed to complete a connection for data communications into and out of the building. Such an installation typically requires a trained professional installer and can be costly and time consuming and may result in property damage.

### SUMMARY

According to an embodiment, customer premises equipment (CPE) includes separate outdoor and indoor data communication units between which wireless optical data communications are transferable through a window of a building. The outdoor data communication unit has an optical transceiver for transmitting and receiving the wireless optical data communications and a wireless power transfer unit for powering the optical transceiver. The indoor data communication unit has a corresponding optical transceiver for transmitting and receiving the wireless optical data communications and a wireless power transfer unit for powering or charging the wireless power transfer unit of the outdoor data communication unit by wireless power transfer.

According to another embodiment, customer premises equipment (CPE) for transferring data communications between an electronic component located exterior of a building to an electronic component located interior of the building includes an outdoor data communication unit for communicating with a separate indoor data communication by wireless optical data communications through a window of a building. The outdoor data communication unit has an optical transceiver for transmitting and receiving the wireless optical data communications and a wireless power transfer unit that powers the optical transceiver and that includes an inductive coil antenna for being powered or charged by resonant inductive coupling.

According to a further embodiment, customer premises equipment (CPE) for transferring data communications between an electronic component located exterior of a building to an electronic component located interior of the building includes an indoor data communication unit for communicating with a separate outdoor data communication by wireless optical data communications through a window of a building. The indoor data communication unit has an optical transceiver for transmitting and receiving the wireless optical data communications and has a wireless power transfer unit with an inductive coil antenna that that powers or charges the outdoor data communication unit by resonant inductive coupling.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a perspective view of a customer premises showing typical broadband installation locations.

FIG. 2 is a perspective view of a customer premises showing an example of a broadband installation location according to an embodiment.

FIG. 3 is a schematic view of Customer Premises Equipment (CPE) used to connect external networks to a wireless local area network according to an embodiment.

FIG. 4 is a schematic view of an outdoor unit (ODU) and an indoor unit (IDU) of CPE in accordance to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

The term “Wi-Fi” refers to a technology for wireless local area networking of electronic devices, for instance, as based on IEEE 802.11 standards, 802.11 is an evolving family of specifications for wireless local area networks (WLANs) developed by a working group of the Institute of Electrical and Electronics Engineers (IEEE). These standards, for instance, define various frame types that stations (network interface cards and access points) used for communications, as well as for managing and controlling wireless links. A Wi-Fi network, such as a wireless local area network (WLAN) may be provided at a home, residence facility, business, or the like customer premises for providing Wi-Fi service to various wireless electronic client devices of the customer at a customer premises.

Broadband access may be provided to the customer premises by connecting the WLAN at the customer premises to an external network, such as an access network, a service provider's network, a wide area network, the Internet, or the like.

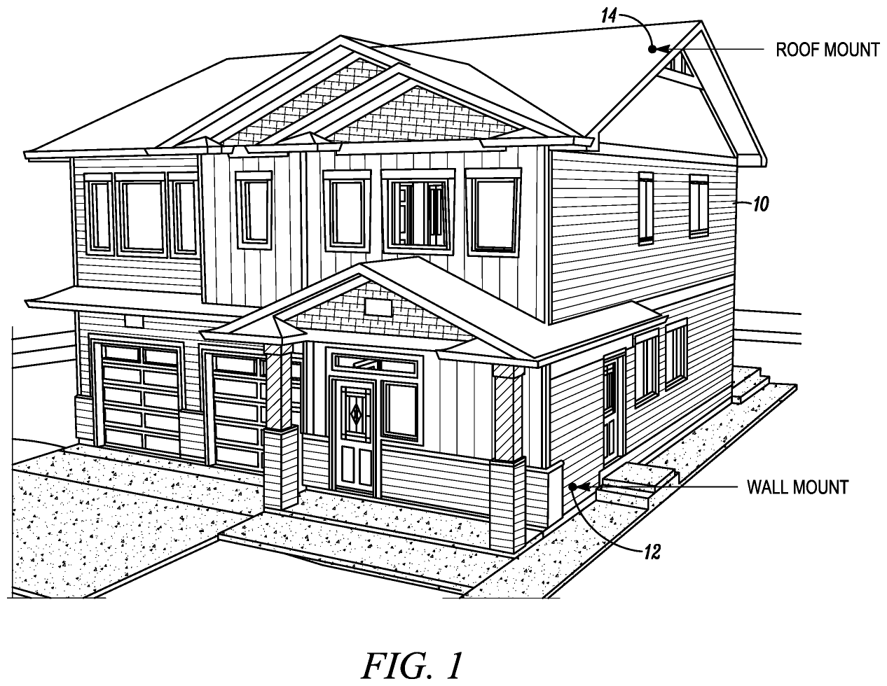

Typically, the so-called “last meter” of broadband access provided to the customer premises is provided by drilling holes through walls or roofs of a building and extending cables, wires, or the like therethrough during an installation process. For instance, such installations at the home 10 shown in FIG. 1 may be provided at a wall mount location 12 (i.e., for connection to a cable or optical network) or a roof mount location 14 (i.e., for connection to a satellite dish or cellular mobile network). One or more holes would be drilled through the building at these locations to attach CPE to walls or roofs and to permit data and/or power wires, cables and the like to be extending into an interior of the building from an exterior of the building.

In accordance to an embodiment, wireless connectivity and power are used in the “last meter” of broadband access and thereby eliminate conventional requirements of drilling holes or channels through walls or roofs of buildings through which wires or cables are extended. The wireless connectivity is accomplished by optical communication technology and the wireless powering of CPE is accomplished by wireless charging technology.

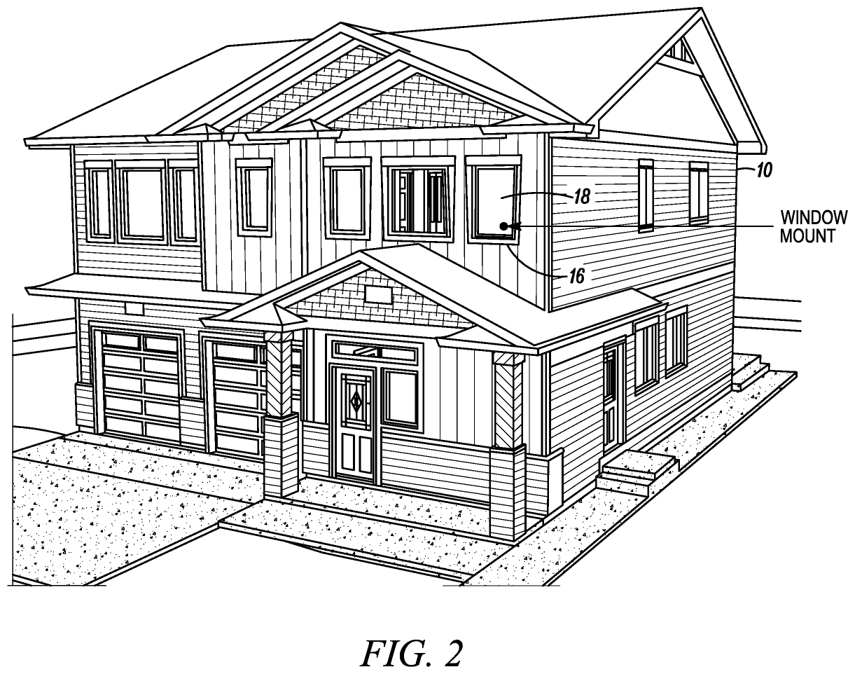

Thus, according to an embodiment, the so-called “last meter” of broadband access is provided to a customer premises through glass or like material through which light may pass. For instance, such material may be provided by a window or the like of a building. For example, as shown in FIG. 2, broadband access may be provided to the customer premises by connecting the WLAN at the customer premises to an external network, such as an access network, a service provider's network, a wide area network, the Internet. or the like via an installation at the home 10 at a window mount location 16 (i.e., wireless connectivity and powering through a glass window 18). Of course, the location 16 could be at any window or the like of the home 10. Such a window 18 may be a single, double, or triple glazed glass window or any other material through which light may be transmitted.

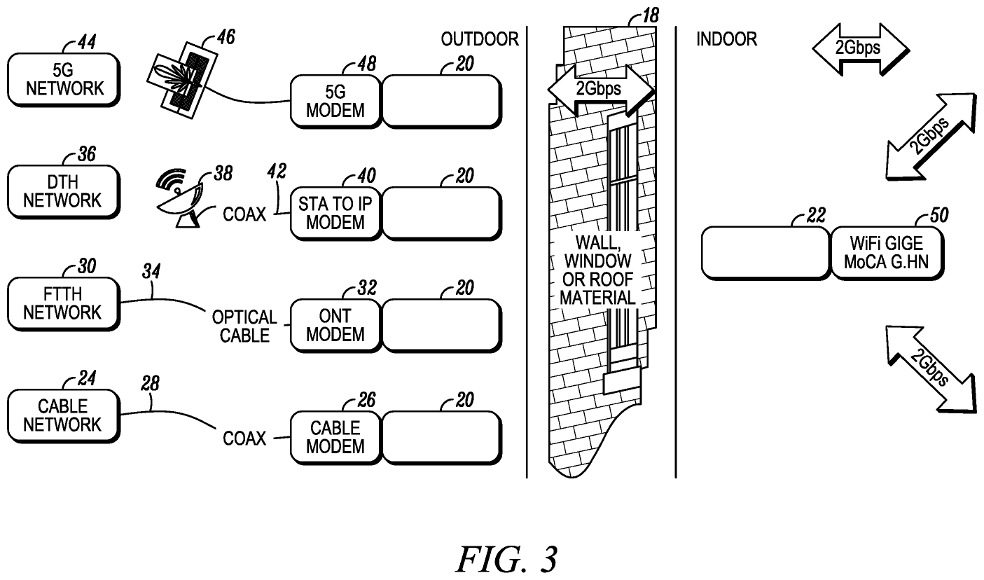

In accordance with an embodiment as shown in FIG. 3, the CPE may include one or more outdoor units (ODUs) 20 and an indoor unit (IDU) 22. These units 20 and 22 are located/mounted on opposite sides of the window 18 (i.e., ODU 20 is mounted on an exterior surface of the window 18 and IDU 22 is mounted on an interior surface of the window) such that the units. 20 and 22, face each other and can communicate via direct line-of-sight optical communications through the window 18. The ODU 20 and IDU 22 may be of relatively small size as compared to the size of the window 18 as to not greatly impact the homeowners view through the window 18 or natural light passing through the window into the home 10.

According to this embodiment, drilling of holes through walls and/or roofs and extending data cables or wires through a wall, roof, or like structure of the home is not required. In addition, a power cable passing through the wall, roof, or like structure of the home 10 is also not required because the ODU 20 is configured to be powered by the IDU 22 via wireless power transfer or charging.

In FIG. 3, multiple ODUs 20 are shown for the purpose of showing that the CPE (i.e., ODU 20 and IDU 22) may be connected to a variety of different external networks. For instance, a cable network 24 may connect to a cable modem 26 via coaxial cable 28. The modem 26 may be directly connected to the ODU 20 or form a part thereof. In addition, a Fiber to the Home (FTTH) network (i.e., optical fiber network) 30 may connect to an Optical Network Termination (ONT) modem 32 via fiber optical cable 34. The modem 32 may be directly connected to the ODU 20 or form a part thereof. Further, a Direct-To-Home (DTH) television network 36 may communicate via satellite signals with a personal dish 38 located at the customer premises and be connected to a SAT to IP modem 40 via coaxial cable 42 or the like. The modem 40 may be directly connected to the ODU 20 or form a part thereof. Still further, a cellular mobile communication network 44 may communicate via cellular communications to an antenna 46 or the like connected or forming part of a modem 48. The modem 48 may be directly connected to the ODU 20 or form a part thereof.

The cellular network 44 may be such that the signals transmitted thereby may not readily and reliably penetrate through walls, roofs and glass of a building. Thus, CPE will be required to distribute data communications from the cellular network 44 throughout the home 10. For instance, the cellular network may be a cellular 5G (fifth generation) network or other network.

As shown in FIG. 3, any one of the ODUs 20 may communicate through the window 18 to the IDU 22. The IDU 22 may be connected to CPE 50 (i.e., a gateway device, router, or the like) providing a gateway and/or access point of a wireless local area network (WLAN) provided in the home 10. Alternatively, the CPE 50 may form part of the IDU 22.

The CPE 50 may be configured to provide a Wi-Fi network within the home 10 as discussed above and/or a gigabit Ethernet (GigE) or other ethernet connectivity, Multimedia over Coax Alliance (MoCA) connectivity, and/or G.Hn connectivity. G.Hn is a specification for home networking with data rates up to 2 Gbit/s and operation over four types of legacy wires: telephone wiring, coaxial cables, power lines, and plastic optical fiber. A single G.Hn semiconductor device is able to network over any of the supported home wire types.

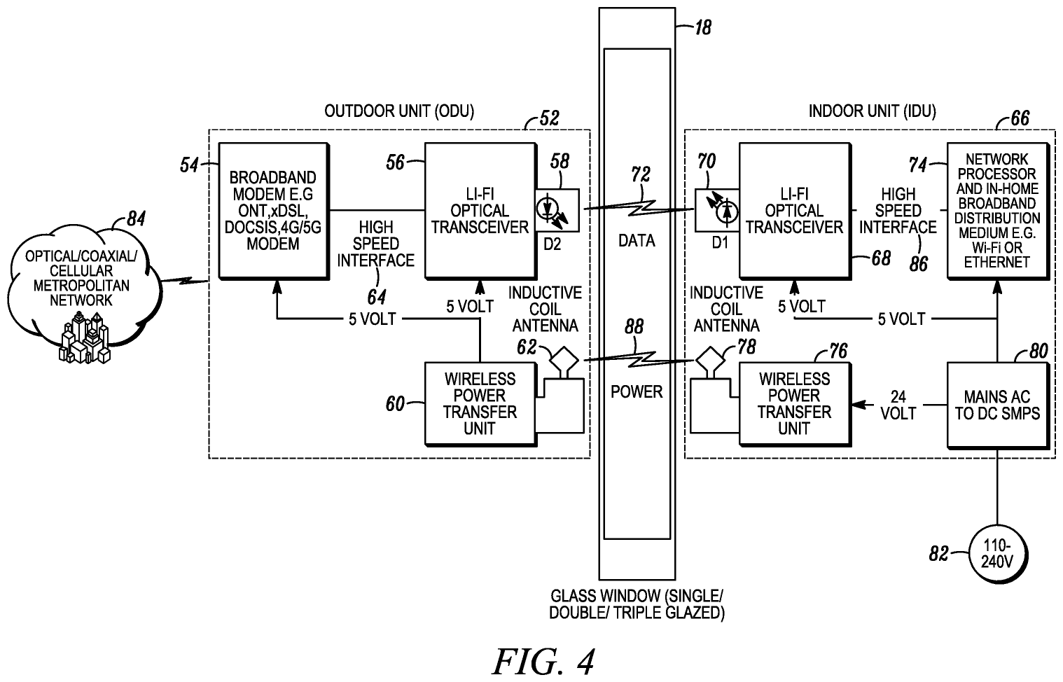

An embodiment of an ODU 52 is shown in FIG. 4. The ODU 52 includes a broadband modem 54, a Light Fidelity (Li-Fi) optical transceiver 56 having one or more sets of light emitting diodes (LEDs) and photoreceptors 58, a wireless power transfer unit 60, and an inductive coil antenna 62. The broadband modem 54 may be any type of modem including those discussed above (i.e., cable (DOCSIS), ONT, xDSL, cellular, 4G/5G, SAT to IP, etc.).

The optical transceiver 56 may be a Light Fidelity (Li-Fi) optical transceiver which uses light-emitting diodes (LEDs) for wireless optical data transmission. LiFi data is transmitted by LEDs and received by photoreceptors. Visible light communications (VLC) is provided by switching the current to the LEDs off and on at a very high rate. If desired, the LEDs may be dimmed to below human visibility while still emitting sufficient light to carry data. Operation of the LEDs is controlled by a microchip or the like that modulates light imperceptibly for optical data transmission. Thus, Li-Fi technology provides a light communications system that is capable of transmitting data at high speeds over the visible light spectrum as well as via ultraviolet and infrared radiation. Unlike Wi-Fi signals, Li-Fi communications are not susceptible to electromagnetic interference and are more secure from hacking.

In addition to Li-Fi. IEEE 802.11bb light communication technology or its equivalent may also be utilized. IEEE 802.11bb defines one medium access control (MAC) and several physical layer (PHY) specifications for light-based wireless connectivity for fixed, portable, and moving stations within a local area network.

The light communications according to an embodiment may provide multi-billions of bits per second (Gbps) broadband communications, such as 2 Gbps or 5 Gbps. Gbps is a measure of bandwidth on a digital data transmission medium.

As shown in FIG. 4, the broadband modem 54 of ODU 52 connects to an external network 84 and interfaces with the optical transceiver 56 via a high-speed interface 64 and both the broadband modem 54 and optical transceiver 56 are powered by the wireless power transfer unit 60 (i.e., receiver unit converting magnetic field picked up from the receiver coil 62 and rectifying/converting to a DC voltage for powering the optical transceiver 56 and broadband modem 54). For instance, the wireless power transfer unit 60 may be configured to provide power at 5 volts or any other desired rated voltage.

The inductive coil antenna 62 enables the wireless power transfer unit 60 of the OPU 22 to be wirelessly powered. By way of example, wireless powering may be accomplished according to the Qi standard which is an open interface standard that defines wireless power transfer using inductive charging over distances of up to 4 cm (1.6 inches) and that was developed by the Wireless Power Consortium. The charging is accomplished by resonant inductive coupling. For instance, the ODU 52 may be powered by the IDU 66. According to an embodiment, the IDU 66 may be configured to deliver about 30 Watts or more or less of power through a glass window of about 3 cm thickness.

The IDU 66 may include a Li-Fi optical transceiver 68 having one or more sets of LEDs and photoreceptors 70 for transfer of data communications 72 with the Li-Fi optical transceiver 56 of the ODU 52. The Li-Fi optical transceiver 68 may communicate via a highspeed interface 86 with a network processor 74 and broadband distribution medium (i.e., Wi-Fi, Ethernet, or the like) within the IDU 66. The network processor may provide or control an access point to the WLAN within the home.

The IDU 66 may also include a wireless power transfer unit 76, an inductive coil antenna 78, and a switched-mode power supply (SMPS) 80. The SMPS 80 is an electronic power supply that incorporates a switching regulator to convert electrical power efficiently and to transfer power from a DC or AC source to DC loads while converting voltage and current characteristics. In FIG. 4, the SMPS 80 is shown connected to an AC power source 82 and to provide the Li-Fi optical transceiver 68 and network processor 74 with power at 5 volts. The SMPS 80 may be configured to provide power, for instance at 24 volts or other rated voltage, to the wireless power transfer unit 76 which may be configured with the inductive coil antenna 78 to wirelessly power the wireless power transfer unit 60 via resonant inductive coupling 88 applied to the inductive coil antenna 62 of the ODU 52 as a receiver. Thus, the ODU 52 is powered/charged by the IDU 66.

Accordingly, the outdoor data communication unit 52 interfaces with the optical, coaxial, cellular, metropolitan wireless network, or other external network 84, and the indoor data communication unit 66 is coupled to the consumers home gateway/indoor terminating device 74. The ODU 52 and IDU 66 are coupled through a glass window 18 in the home using optical modulators to transceive data between the ODU 52 and IDU 66 via optical physical layer Li-Fi technology or the like. In addition, the ODU 52 is powered by wireless powering the ODU 52 by the IDU 66 using wireless resonant inductive coupling. The antennas 62 and 78 of the ODU 52 and IDU 66 are configured to be optimized for near field communication thus making it possible to wirelessly transmit power from the IDU 66 to the ODU 52.

The above described ODU and IDU may be provided in relatively compact sizes of relatively light weight and may be readily secured to a surface of a glass window. For example, each of the ODU and IDU may be supported by a support bracket or stand secured or fastened to the sill or surrounding structure of a window. Alternatively, the ODU may be secured to the window with adhesives, suction cups, or the like. Installation of the ODU and IDU should reduce operator liability and risk for property damage and should be able to be installed in a very short period of time. Alignment of the IDU with the ODU should be simple permitting this function to be performed by the homeowner or like untrained person. Thus, a professional installer may not be required to enter the customer premises as the IDU may be able to be secured to a surface of the window by the consumer (i.e., homeowner or the like). The connection can provide a direct line-of-sight between the optical transceivers of the ODU and IDU and thus should be immune from interference and should be able to provide high-speed data communications (i.e., up to 5 Gbps).

A system for carrying out any of the above disclosed embodiments, methods, or arrangements may include software or the like provided on a circuit board or within another electronic device and can include various routers, modems, processors, microprocessors, modules, units, components, controllers, chips, disk drives, and the like. It will be apparent to one of ordinary skill in the art that gateways, routers, modems, systems, modules, components, units, processors, servers, and the like may be implemented as electronic components, software, hardware or a combination of hardware and software for purposes of providing a system.

While the principles of the invention have been described above regarding specific devices, apparatus, systems, and/or methods, it is to be clearly understood that this description is made only by way of example and not as limitation. One of ordinary skill in the art will appreciate that various modifications and changes can be made without departing from the scope of the claims below.

The above description illustrates various embodiments along with examples of how aspects of particular embodiments may be implemented, and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims.

1. A customer premises equipment (CPE) apparatus, comprising:
an outdoor data communication unit and a separate indoor data communication unit between which wireless data communications are transferable through a window of a building;
wherein each of the outdoor and indoor data communication units has an optical transceiver for transmitting and receiving wireless data communications therebetween such that the wireless data communications are wireless optical data communications;
wherein each optical transceiver includes a light emitting diode (LED) configured to transmit the data communications with light below human visibility;
wherein the outdoor data communication unit has a wireless power transfer unit which powers the optical transceiver of the outdoor data communication unit; and
wherein the indoor data communication unit has a wireless power transfer unit that charges the wireless power transfer unit of the outdoor data communication unit by wireless power transfer.

2. The CPE apparatus according to claim 1, wherein each of the wireless power transfer units includes an inductive coil antenna, and wherein the wireless power transfer is by resonant inductive coupling.

3. The CPE apparatus according to claim 1, wherein the outdoor data communication unit is adapted for being mounted adjacent an exterior surface of the window of the building and the indoor data communication unit is adapted for being mounted adjacent an interior surface of the window of the building opposite the outdoor data communication unit such that the window extends between the outdoor and indoor data communication units and such that the wireless optical data communications and wireless power transfer pass through the window.

4. The CPE apparatus according to claim 1, wherein the optical transceivers of the outdoor and indoor data communication units are configured to transmit and receive wireless, direct line-of-sight, light communications therebetween.

5. The CPE apparatus according to claim 1, wherein the wireless optical data communications are at least one of, ultraviolet (UV) electromagnetic radiation communications, and infrared electromagnetic radiation communications.

6. The CPE apparatus according to claim 1, wherein each of the optical transceivers are Light Fidelity (Li-Fi) optical transceivers including the light emitting diode (LED) and a photoreceptor by which wireless, direct line-of-sight, light communications are transmitted and received.

7. The CPE apparatus according to claim 1, wherein the outdoor data communication unit includes a broadband modem that interfaces with the optical transceiver of the outdoor data communication unit.

8. The CPE apparatus according to claim 7, wherein the broadband modem is selected from a group consisting of a cable modem, an optical network termination (ONT) modem, a satellite to Internet Protocol (SAT to IP) modem, and a cellular modem.

9. The CPE apparatus according to claim 7, wherein the broadband modem is powered by the power transfer unit of the outdoor data communication unit.

10. The CPE apparatus according to claim 7, wherein the broadband modem is adapted for being interconnected to at least one of a wide area network, an access network, a service provider's network, the Internet, a cable network, a fiber-to-the-home network (FTTH), a direct-to-home (DTH) network, and a cellular mobile communication network.

11. The CPE apparatus according to claim 1, wherein the indoor data communication unit includes a switched-mode power supply (SMPS) that provides power to the optical transceiver and the wireless power transfer unit of the indoor data communication unit.

12. The CPE apparatus according to claim 1, wherein the indoor data communication unit includes a network processor for a local area network, and wherein the network processor interfaces with the optical transceiver of the indoor data communication unit.

13. A Customer Premises Equipment (CPE) system for transferring data communications between an electronic component located exterior of a building to an electronic component located interior of the building, comprising:
an outdoor data communication unit for communicating with a separate indoor data communication unit by wireless optical data communications through a window of the building;
the outdoor data communication unit having an optical transceiver for transmitting and receiving the wireless optical data communications;
the optical transceiver including a light emitting diode (LED) configured to transmit the data communications with light below human visibility; and
the outdoor data communication unit having a wireless power transfer unit that powers the optical transceiver and that includes an inductive coil antenna for being charged by resonant inductive coupling.

14. The CPE system according to claim 13, wherein the outdoor data communication unit is adapted for being mounted adjacent an exterior surface of the window of the building.

15. The CPE system according to claim 13, wherein the optical transceiver of the outdoor data communication unit is configured to communicate with the indoor data communication unit with wireless, direct line-of-sight, optical communications using at least one of ultraviolet (UV) electromagnetic radiation, and infrared electromagnetic radiation.

16. The CPE system according to claim 15, wherein the optical transceiver is a Light Fidelity (Li-Fi) optical transceiver including the light emitting diode (LED) and a photoreceptor by which the wireless, direct line-of-sight, light communications are transmitted and received.

17. The CPE system according to claim 13, wherein the outdoor data communication unit includes a broadband modem that interfaces with the optical transceiver of the outdoor data communication unit.

18. A Customer Premises Equipment (CPE) system for transferring data communications between an electronic component located exterior of a building to an electronic component located interior of the building, comprising:
an indoor data communication unit for communicating with a separate outdoor data communication unit by wireless optical data communications through a window of the building;
the indoor data communication unit having an optical transceiver for transmitting and receiving the wireless optical data communications;
the optical transceiver including a light emitting diode (LED) configured to transmit the data communications with light below human visibility; and
the indoor data communication unit having a wireless power transfer unit with an inductive coil antenna that charges the outdoor data communication unit by resonant inductive coupling.

19. The CPE system according to claim 18, wherein the indoor data communication unit includes a network processor for a local area network, and wherein the network processor interfaces with the optical transceiver.

20. The CPE system according to claim 19, wherein the indoor data communication unit includes a switched-mode power supply (SMPS) that powers the optical transceiver, network processor, and the wireless power transfer unit.
